(19) United States
(12) Patent Application Publication
(10) Pub. No.: US 2025/0050769 A1
(43) Pub. Date: Feb. 13, 2025

(54) SYSTEMS AND METHODS FOR ENERGY MANAGEMENT AND DEMAND-BASED INSTALLATION OF CHARGING STATIONS

(71) Applicant: Moon Five Technologies, Inc., Berkeley, CA (US)

(72) Inventor: Stephan Andrew Ng, Berkeley, CA (US)

(21) Appl. No.: 18/801,297

(22) Filed: Aug. 12, 2024

Related U.S. Application Data
(60) Provisional application No. 63/519,041, filed on Aug. 11, 2023.
(60) Provisional application No. 63/592,465, filed on Oct. 23, 2023.
(60) Provisional application No. 63/667,865, filed on Jul. 5, 2024.

(51) Int. Cl. B60L 53/30; H02J 3/14; H02J 9/06; H04L 12/40

(52) U.S. Cl. CPC B60L 53/305; H02J 3/144; H02J 9/068; H04L 12/40032; H04L 12/40045; H04L 2012/40215; H04L 2012/40273

(57) ABSTRACT

Systems and methods for energy management and demand-based installation of charging stations are described. In one aspect, a modular charger unit includes a housing configured to receive cartridges; an interconnect board with slots configured to receive boards housed in cartridges; a computational board housed in a cartridge removably inserted to a first opening of the housing and to a first slot of the interconnect board; a variable high voltage output board housed in a cartridge removably inserted to a second opening of the housing and to a second slot of the interconnect board; a power board housed in a cartridge removably inserted to a third opening of the housing and to a third slot of the interconnect board; and an optional board housed in a cartridge removably inserted to a fourth opening of the housing and to a fourth slot of the interconnect board.

### CROSS-REFERENCE TO RELATED APPLICATIONS

This application claims benefit to U.S. Provisional Patent Applications 63/519,041, entitled “METHOD AND SYSTEM FOR DYNAMIC LOAD ALLOCATION BETWEEN CHARGING UNITS IN VEHICLE CHARGING NETWORKS,” filed on Aug. 11, 2023; 63/592,465, entitled “METHOD AND SYSTEM FOR DEMAND BASED INSTALLATION BETWEEN CHARGING UNITS IN VEHICLE CHARGING NETWORKS,” filed on Oct. 23, 2023; and 63/667,865, entitled “ENERGY DISTRIBUTION AND DYNAMIC LOAD MANAGEMENT WITHIN MULTI-TENANT DWELLINGS,” filed on Jul. 5, 2024. The aforementioned United States Provisional Patent Applications are incorporated herein by reference.

### FIELD OF TECHNOLOGY

The present disclosure relates generally to methods and systems directed to (i) communicatively coupling commercial charging units within vehicle charging networks; (ii) demand-based commercial charging unit installation for vehicle charging networks; and (iii) energy management and load distribution for multi-tenant dwellings (e.g., apartment complexes) that feature one or more vehicle charging stations.

### BACKGROUND

In commercial electric vehicle charging, when the design of the power delivery system in an electric vehicle charging network (EVCN) is based on the amount of power that all the electric vehicle charging stations (EVCS) installed can draw at once, the total number of EVCS is limited by the total amount of power delivered to the EVCN. For instance, when there are only 100 amp available for distribution between the EVCS in an EVCN, and each EVCS is configured to draw 10 amps at 240 Volts AC, the number of EVCS in the EVCN may not increase above 10 without a costly breaker box upgrade, or expensive transformer upgrades.

Further, in commercial vehicle charging installations, charging station components (such as breaker boxes or upgrades thereof, wiring, and charging units) are typically installed concurrently, which can result in a high upfront cost for the conversion of regular parking spaces to electric vehicle (EV) charging spaces in parking garages and open parking lot structures. Additionally, the coexistence of internal combustion engine vehicles and EVs requires a system with electric vehicle charging capabilities that is immune to in-field electronics degradation, which can further inflate the operational and ownership costs of the charging units.

Lastly, in apartment complexes, the electrical capacity is often insufficient for components with high power demands, such as EVCS in an EVCN. As a result, charging station operators rely on dynamic load allocation to prevent overloading the breaker box's limited capacity. Consequently, upgrading the breaker box is necessary to handle the additional electrical load. These upgrades may also require new service lines and transformer enhancements, which further increase the cost of ownership.

Accordingly, there is a need for systems and methods that can provide in a cost-effective manner dynamic power allocation to efficiently utilize the available power that enables the growth of the EVCN based on the total number of charging stations, on demand-based installation for the EVCS within the EVCN, and a dynamic load management system for EVCNs to address the above shortcomings.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### BRIEF SUMMARY

Typically, for a small scale charging network, a signal to pull less power is communicated to a vehicle charger, allowing the power distribution system of the small scale network to split the power consumption between, for example, two charging electric vehicles (EVs) equally. For example, in a 6.6 kW charging station where there is single EV charging, the vehicle can draw 6.6 kW. However, when there are two vehicles charging, each vehicle is requested to pull 3.3 kW. This concept has been successfully demonstrated via a single control board for a limited number of charging stations. However, this scheme can be harder to implement for a large number of EV charging stations. According to some embodiments, the disclosed method and system scale this concept to a larger number of charging stations by forming a network node in which all the charging stations within, for example, a parking structure, are able to communicate with each other. This approach allows the transmission of information within the charging stations in the network node, which improves reliability by creating redundancy, and offers maximum power delivery by switching charging stations between a high power (high current) mode (e.g., up to 240 Volt alternating current (AC) at 40 amps) and a low power (low current) mode (240 Volt AC at 10 amps).

Traditionally, EV charging infrastructure requires a single process installation. This means that all components of the charging infrastructure are installed together. This process can include recurring costs associated with the installed system, such as networking fees, software fees, and maintenance fees. This can be a capital intensive process that can discourage a prospective client (e.g., a property owner or a business) from installing additional units and/or assuming the risk of an unproven demand or usage from potential customers (e.g., tenants or business customers). According to another embodiment, the method and system disclosed herein allow prospective clients to divide the upfront cost associated with the installation process into independent sub-processes that may occur at different times. By way of example and not limitation, electrical infrastructure upgrades, such as copper wiring, subpanel and initial breaker box installation, may occur separately (e.g., at a different time) from the electric vehicle charging station (EVCS) installation, which may be accompanied by an asynchronous breaker box upgrade that adds capacity to an existing electrical node. Accordingly, a client (e.g., a property owner) may initially decide to install the backbone of the charging network (e.g., the electrical infrastructure), and only proceed with the actual EV charger installation when there is demand for an EV charger from a customer (e.g., a tenant). Additionally, the client may install a backplate for a charging system as part of the backbone installation so that the electrical wiring of the backbone terminates to a covered connector housed within the backplate. By way of example and not limitation, the covered connector can be a pluggable, commercially available, terminal block, such as a Phoenix Connector 1913523. The backplate may also contain instructions for an assigned parking space in the form of a quick-response (QR) code or near field communication (NFC) tag, which a user of the parking space may scan or interact with via an appropriate reading device (e.g., a smartphone) to initiate a commissioning process when the assigned parking space can be switched from a “combustion engine vehicle” space to “an electric vehicle” space.

As discussed above, energy intensive systems, like EVCSs, often require changes to existing electrical infrastructure in apartment complexes settings, such as breaker boxes upgrades, transformer upgrades, service line upgrades, etc. in order to deliver more power to EVs connected to them. These upgrades can substantially delay a project's timeline, which can significantly hamper deployment rates of EV technology. According to yet another embodiment, the disclosed method and system allow installers to divert power not used by a tenant's electrical circuit towards a high current application (HCA), such as electric vehicle charging. That is, unused electric power can be diverted directly from the circuit breaker of the tenant rather than from a circuit breaker box dedicated towards a common energy of the entire complex. Accordingly, the current redistribution may occur downstream of the meter and the master breaker. Advantageously, the disclosed method and system, according to the this embodiment, can determine the amount of energy being used and adjust the output of the HCA to ensure that the total amount of energy drawn by the system is 80% below the capacity of the circuit.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a simplified schematic diagram of an exemplary network node connecting devices of an electrical node, in accordance with some embodiments.

FIG. 2 flowchart of operations executed by a transmitting device when the device is triggered by a user, in accordance with some embodiments.

FIG. 3 is a schematic representation of an exemplary electrical node in which devices are within a range of a wireless mesh network, in accordance with some embodiments.

FIG. 4 is a schematic representation of an exemplary electrical node with two sub-clusters communicatively disconnected from one another, in accordance with some embodiments.

FIG. 5 is a schematic representation of an exemplary electrical node with two sub-clusters communicatively connected to each other via a repeater, in accordance with some embodiments.

FIG. 6 illustrates the exemplary node of FIG. 5 when one of the devices in a sub-cluster becomes unresponsive, in accordance with some embodiments.

FIG. 7 is a schematic wiring diagram for a modular charger unit installed on an exemplary backbone electrical infrastructure, in accordance with some embodiments.

FIG. 8 shows modular internal components of a modular charger unit, in accordance with some embodiments.

FIG. 9 schematically describes an exemplary commissioning process for a modular charger unit, in accordance with some embodiments.

FIG. 10 is an isometric view of an exemplary energy management system (EMS) unit, in accordance with some embodiments.

FIG. 11 is a block diagram of an exemplary electrical wiring for an EMS unit in a four-unit apartment setting, in accordance with some embodiments.

FIG. 12 is a schematic diagram of an exemplary electrical configuration within an EMS unit when the EMS unit has no power cartridges installed, in accordance with some embodiments.

FIG. 13 is a schematic diagram of an exemplary electrical configuration within an EMS unit when power cartridges for all apartments are installed, in accordance with some embodiments.

FIG. 14 shows the schematic diagram of FIG. 13 during a power outage scenario, in accordance with some embodiments.

FIG. 15 shows an alternative electrical configuration of FIG. 13, in accordance with some embodiments.

FIG. 16 is a schematic diagram of an exemplary switchboard electrical configuration within an EMS unit, in accordance with some embodiments.

FIG. 17 is an exemplary power cartridge of an EMS unit with two high current application (HCA) position connectors, in accordance with some embodiments.

FIG. 18 is an exemplary wiring configuration of four apartment units sharing two electric vehicle (EV) chargers in hypothetical spots 1 and 2, in accordance with some embodiments.

FIG. 19 shows two possible EMS configurations, in accordance with one embodiment.

FIG. 20 shows an alternative EMS configuration with a hardwired high current application (HCA) output in the form of a plug connector, in accordance with one embodiment.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

### I. Vehicle Charging Networks

### A. Description of the Vehicle Charging Network

According to some embodiments, the disclosed vehicle charging network, referred to herein as a network node, can communicatively couple vehicle charging stations across one or more clusters of charging stations within a property, such as parking garage or parking lot. In some embodiments, the charging stations in a cluster may share a common power supply line but may not share the same power supply line with other devices in other clusters. According to some embodiments, each of these clusters of charging stations is referred to herein as an electrical node, and each charging station within an electrical node is referred to herein as a device. Accordingly, a property may include one or more electrical nodes whose devices are communicatively coupled via the disclosed network node.

In some embodiments, the network node is configured to: (i) allow communication between all the devices across the electrical nodes in the property; and (ii) specifically enable the devices within each electrical node to communicate electrical power distribution information with one another. For example, in a scenario where a parking lot has two electrical nodes of devices, e.g., a first electrical node with public charger stations and a second electrical node with private charger stations, the disclosed node network provides a communication channel between the devices in the two electrical nodes and enables, for example, the devices on the second electrical node (e.g., the private charger stations) to exchange power distribution information related to the second electrical node.

In some embodiments, the disclosed network node is a network infrastructure that unitizes two types of networks: (i) a wireless mesh network, which allows the devices across the electrical nodes to directly communicate with one another; and (ii) a server system, which allows the devices across the electrical nodes to communicate with each other via a server operated on an online wireless network. According to some embodiments, the wireless mesh network is an offline sub-network that is not connected to the internet. In contrast, the server system is an online wireless sub-network connected to the internet.

In some implementations, the network node may utilize both sub-networks (the wireless mesh network and the server system) to enable devices on the electrical nodes to communicate with each other and operate with improved stability and flexibility. For instance, when direct communication between devices is not possible or disrupted, the network node can rely on the server system for the communication between the devices and the other way around. In some implementations, the network node may utilize both sub-networks (the wireless mesh network and the server system) concurrently. In other words, all devices across the electrical nodes are connected over the internet as well as via the wireless mesh network. In other embodiments, communication over the wireless mesh network may be prioritized over the server system to avoid bandwidth issues inconsistent reception, and delays associated with sending information to a server and retrieving that information.

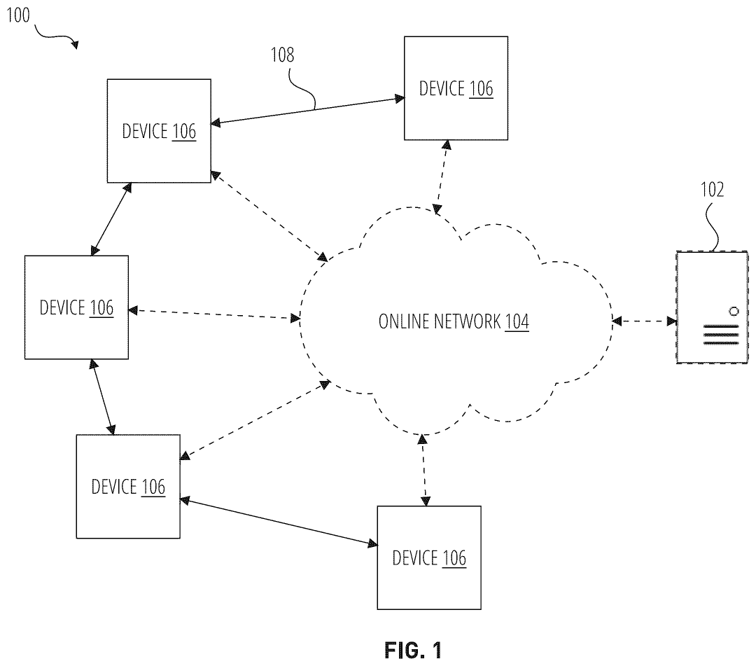

According to some embodiments, FIG. 1 shows a simplified schematic diagram of an exemplary electrical node 100, which includes a cluster of devices 106 that share the electrical power supplied to the electrical node 100. Devices 106 are communicatively coupled to each other via a network node which includes a wireless mesh network as represented in FIG. 1 by direct wireless connections 108 between the device 106, and a server system which includes a server 102 communicatively coupled to devices 106 of electrical node 100 via an online network 104.

According to some embodiments, the wireless mesh network formed by the wireless connections 108 is an offline wireless sub-network that allows devices 106 to exchange information directly with one another in a quick and efficient manner. In the context of a network, the term “offline” refers to a type of network that operates without an active internet connection. Thus, the wireless mesh network allows devices 106 to communicate within a localized environment. In some embodiments, the wireless mesh network can be a line-of-sight or a short range continuous network that utilizes suitable communication protocols, such as Bluetooth® or the IEEE 802.11 standards (e.g., Wi-Fi). In the same token, online network 104 can be any suitable wireless network that can provide internet connectivity, such as Wi-Fi, satellite connection, cellular, etc.

In some embodiments, when connection between devices 106 becomes unstable or unavailable, the network node relies on the appropriate sub-network (the wireless mesh network, the server system, or combinations thereof) to ensure proper and continuous connectivity between the devices within the same or different electrical nodes. For example, the network node can provide connection to a device within a property, which would otherwise be offline. By way of example, this can be beneficial in situations where a device is installed in an underground garage location with no internet connectivity via, for example, cellular coverage. This device, which would have otherwise been offline, may be now connected via the wireless mesh network of the network node to another device that is within range of the online network 104.

In some implementations, the network node may provide communication within the electrical node 100 primarily through the wireless mesh network, which offers a quicker and safer communication between devices 106 when the conditions permit, and utilize the server system (the online network 104 and server 102) when it is necessary to re-establish a broken communication channel between the devices 106 in electrical node 100 or between the devices 106 and the devices of neighboring electrical nodes. However, this is not limiting, and network node may connect the devices 106 in electrical node 100, and to devices of neighboring electrical nodes, via the wireless mesh network and the server system concurrently.

Although not shown in FIG. 1, the devices 106 of electrical node 100 can communicate, via the network node (the wireless mesh network and the server system) shown in FIG. 1, with devices of neighboring electrical nodes (not shown) to gather status information for those devices. In other words, the network node can establish communication not only between the devices 106 of the electrical node 100 shown in FIG. 1, but also between the devices 106 and other devices of neighboring electrical nodes not shown in FIG. 1.

It is further noted that electrical node 100 may include any number of devices 106 (e.g., two or more, five or more, ten or more, etc.). It is further understood that for simplicity the depiction of electrical node 100 is limited to key components discussed herein. Accordingly, electrical node 100, as would be understood by a skilled artisan, may include any number of suitable additional components that allow electrical node 100 to operate as described herein. These additional components may include any number of hardware and software components. These hardware and software components are within the spirit and the scope of the disclosure.

In some implementations, server 102 may include one or more servers. In further embodiments, server 102 may be a local server or a remote server (e.g., a cloud server) communicatively coupled to the devices 106 via the online network 104 (e.g., the internet, a mobile network, etc.).

In some embodiments, when the devices 106 are set up in a node configuration, such as in electrical node 100, they are pre-programed to contain information related to the electrical node configuration they belong to. This information may be, for example, in the form of pre-programmed values stored in a non-volatile storage medium within each device, and may be determined during the initial device set up. By way of example and not limitation, the stored information may include at least i) the maximum amount of current deployed by the device; ii) the maximum current drawn by the node when all devices are in a charging session at the same time; iii) the total number of devices in the node; and iv) the device's node number n, which is a reference value used to indicate the order in which the device is commissioned within the electrical node. It is noted that each device 106 may also be assigned a user identifier associated with the device, such as a Universally Unique Identifier (UUID), which is programmed into the device during initial testing of the device by its manufacturer.

According to some implementations, the above-noted information stored within each device 106 of electrical node 100, can be transmitted via an initial “heartbeat” signal response when the devices communicate to one another through the sever server system (i.e., via the online network 104 and server 102), and via a message queue telemetry transport (MQTT) protocol when the devices communicate to one another through the wireless mesh network (i.e., via wireless connections 108).

### B. Principles of Operation for the Vehicle Charging Network

According to some embodiments, the maximum current pool (MCP) of the shared variable power in electrical node 100 can be determined based on the maximum current input (MCI) provided to the electrical node minus the maximum current allocation to each device 106 within the electrical node. The maximum current allocation can be expressed, for example, in terms of leg 1 (L1) and leg 2 (L2) of a circuit breaker on which devices 106 are connected to. In this context, L1 and L2 correspond to 120 Volts of alternating current (AC) supplied by an electric power distribution system to the electrical node via a service drop. Since a level-2 power draw can be symmetric, the maximum allotted power on any of the legs can be the limiting factor for the MCP. Accordingly, the MCP may be expressed as:

$$MCP = MCI - max ( L 1 , L 2 ) .$$

Taking the above limitations into account, the goal of the electrical node 100 is to i) determine whether there is sufficient power to allocate to the devices 106 by gathering information from all the devices within the electrical node 100 via the network node; ii) ensure that no device 106 is triggered during the determination process that could potentially overload the circuit breaker to which the devices are connected to; and iii) introduce a “wait time” when the network is at capacity but initiate a charging session when a user is logged-in for a “delayed charging session” (e.g., a pre-set charging session at a convenient for the user timeframe).

To achieve these goals, the devices in electrical node 100 will have to determine via information relayed by the network node which devices are drawing current (e.g., are in a charging session) and which devices are standing by or in low power draw mode. The amount of current for the devices that are unaccounted for, whether online or not, can be provided by equation (1):

$${i}_{unaccounted for} = \sum {i}_{max} . \qquad ( 1 )$$

It is noted that a device 106 in electrical node 100 is considered to be “online” when it is connected to the network node (the wireless mesh network and the server system) and its charging status is known to other devices 106 on the network node. Conversely, a device 106 is considered to be “offline” when it is not connected to the network node and its charging status is unknown to the other devices 106 on the network node. The sum on the right side of equation (1) expresses the maximum amount of current which can be simultaneously pulled by the devices that have not been accounted for yet. For example, in a scenario where there are 10 devices in the electrical node, two of which have not yet replied (i.e., the electrical node is unaware of their charging status) and both these two non-reporting devices have a maximum current draw of 50 amps, the i_{unaccounted for} would be equal to 100 amps (i.e., 50 plus 50). In other words, the electrical node assumes that non-reporting devices of unknown status have a maximum current draw when calculating i_{unaccounted for}.

According to some implementations, the maximum current during a device initiation process in electrical node 100 can be expressed by equation (2):

$${i}_{max from initiating device} \leq MCP - \sum {i}_{in use} - \sum {i}_{unknown} . \qquad ( 2 )$$

In some embodiments, the i_{max from initiating} for a device represents a predetermined threshold value, which once reached, a charging session may commence by the device. At the beginning of a charge initiation process, the maximum current drawn from the electrical node may exceed the total amount of power delivered to the electrical node. Accordingly, the sum of i_{unknown} may exceed the maximum deliverable power to the electrical node (as calculated in the MCP) at the beginning of the calculation. Thus, when a charge initiation process begins, the sum of i_{unnknown} (i.e., the sum of the max current of all non-reporting units) can be equal to or greater than the MCP while the sum of i_{in use} can be zero. This means that the right side of equation (2) may be negative (and thus below the max amount of current threshold for the charge initiation) since the maximum current allocated to a electrical node, if all units have power applied, would exceed the supplied power that is calculated in the MCP. However, as the units begin reporting their status, MCP will remain the same but the sum of i_{unknown} will decrease as more devices report their status and their real-time current output. When a device is in use, its current usage will be captured by the sum of i_{in use}. Once the right side of the equation becomes less than the predetermined value of i_{max from initiating} device, a charging session may commence because whether the “unaccounted for” devices are charging or not will not exceed the power delivered to the electrical node.

It is noted that the aforementioned methodology may be applied to a breaker with up to three phase charging (e.g., L1, L1+L2, and L1+L2+L3). Similarly, the aforementioned methodology may be scaled for industrial applications without limitation.

### C. Operation of the Vehicle Charging Network

According to some embodiments, the operation of the network node discussed above can be substantially similar when utilizing the wireless mesh network and server system. For example, the information exchange that occurs between the devices 106 and the way a device may initiate a charging session can be substantially similar.

When the devices in an electrical node are connected via the server system of the network node, the network node operates as a hub and spoke model where the devices reach out to the system server to exchange information on a regular basis, rather than the system server reaching out to the devices. In order to keep the data rates low, communication will occur somewhat infrequently when there is no valid user interaction. However, when a user approaches one of the devices in the electrical nodes and interacts with the device (e.g., interacts with a user interface mounted on the device or uses an application that wirelessly communicates with the device), he/she will trigger a “heartbeat rate” change event within the electrical node that propagates through the network node. This means that the triggered device, and the devices in the vicinity of the triggered device, may increase the frequency at which the exchange of information occurs between the devices and the system server. In some embodiments, a triggered device may exchange information with the system server every second, twice per second, or at any suitable interval. In some embodiments, when a device is triggered by a user, the communication frequency between all the devices of the electrical node and the system server increases.

By way of example and not limitation, the transmitted information over the network node can be communicated via a representational state transfer (REST) application programming interface (API) call to the system server—i.e., a request made using an API to access data form the system server where data is received over a Hypertext Transfer Protocol (HTTP). As discussed above, it is to be understood that the system server can be a remote server, such as a cloud server or a Cloud Service Provider (CSP).

According to some embodiments, the transmitted information may include at least: i) the device's UUID; ii) a timestamp which can be used to resolve charging initiation conflicts between devices due to signal transmission latency issues; iii) the device's charging status (i.e., whether a device is in a high current charging state, low current charging state, of OFF); and iv) an initiating device node number corresponding to a number that reflects the order at which the device was commissioned.

In some implementations, priority in a charging initiation conflict can be determined by the transmitted timestamp. That is, in a charging initiation conflict scenario between two or more devices 106, the device with the earliest transmitted timestamp will get charging initiation priority over other devices with a later transmitted timestamp, and so on. In further implementations, the device's charging status can indicate to the electrical node the charging state of the device. For instance and without limitation, a device 106 in a high current charging state may have a status represented by a value equal to 2, in a low current charging state may have a status represented by a value equal to 1, while a device 106 in a non-charging state may have a status represented by a value equal to 0. Finally, and with respect to the initiating device node number, which is number with fewer characters than, for example, the device's UUID (which can be in format 2c64dc12-e35a-494e-a626-eb08bddf59e3) can substantially reduce the amount of information being transmitted over the network node. This can be beneficial when information is being transmitted via the wireless mesh network, which may be designed to have limited bandwidth.

When on the wireless mesh network, the devices communicate directly with one another. According to some embodiments, the use of wireless mesh network removes dependencies, such as the reliance on the internet as a way to establish communication between the devices in the electrical node. Accordingly, communication between the devices 106 in the electrical node 100 can be faster and more secure when the node operates in offline mode.

Similar to the case of the server system, the information being exchanged via the wireless mesh network between the devices of the electrical node include: i) a Message ID—a unique identifier generated by the transmitting device allowing for an acknowledgement of the received message by a receiving device; ii) a timestamp which can be used to resolve charging initiation conflicts between devices due to signal transmission latency issues; iii) the device's charging status; iv) and the initiating device node number.

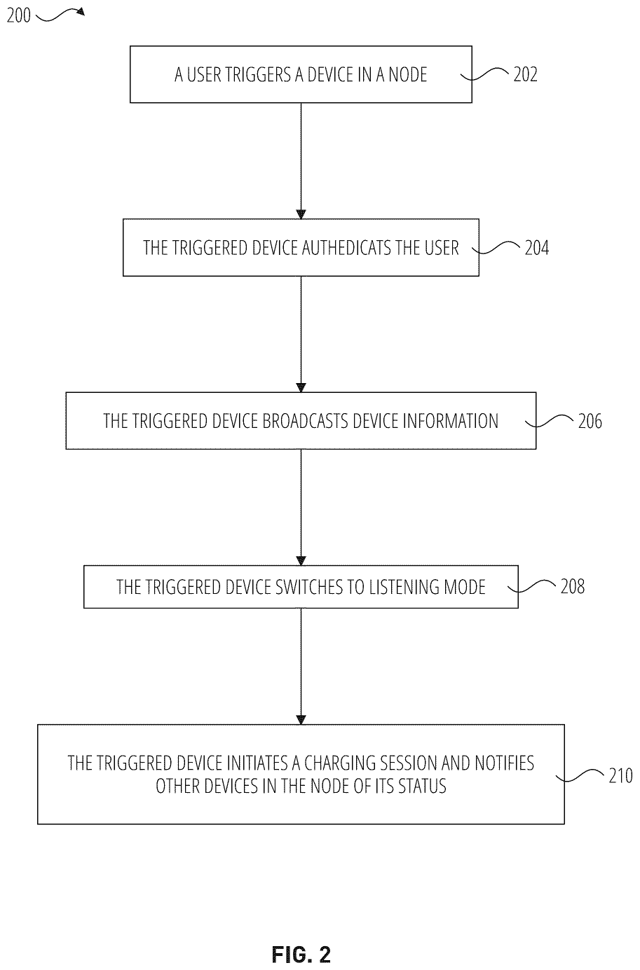

According to some implementations, FIG. 2 is a flowchart 200 that describes the operations executed by a transmitting device in an electrical node operating via the wireless mesh network of the network node when the device is triggered by a user. By way of example and not limitation, the flowchart 200 may be executed within electrical node 100 shown in FIG. 1 using the disclosed network node. By way of example and not limitation, flowchart 200 begins with operation 202 where a user, who wants to use a device 106 to charge his/her EV, triggers the device by interacting with the device. In this context, a user may, for example, use a near field communication (NFC) device, such as a smartphone or an NFC-enabled card, to trigger the device. It is noted that the user may interact with the device via other suitable methods, such as with an application running on his/her smartphone device, or via an interface on the device itself, such as a touch screen, a keypad, and the like.

Once the device is triggered, flowchart 200 proceeds to operation 204 where the user is authenticated by the triggered device. In some embodiments, the triggered device tries to authenticate the user's credentials based on online information it fetches from the network node (i.e., the server system). However, if the triggered device cannot reach the server, it can reference a database of trusted recurring users locally stored on the device to complete the user authentication process.

Once the user is authenticated at operation 204, the flowchart 200 continues with operation 206 where the triggered device (the transmitting device) initiates a broadcast over the wireless mesh network of the network node to the other devices (the receiving devices) connected to the entire network node (i.e., devices within and outside the transmitting device's electrical node). During the broadcast event, the transmitting device transmits the information mentioned above, such as i) the device's UUID, ii) a timestamp corresponding to the triggering event, iii) the device's charging status, and iv) the device's node number. Once the information is transmitted, the transmitting device switches to a listening mode, according to operation 208, during which the device monitors for acknowledgements from the receiving devices.

It is noted that while the device monitors for acknowledgements or while it receives acknowledgements, it may perform, in parallel, other operations. For example, the device can calculate in real-time the Σi_{unknown} or other terms from equation (2) to determine whether a charge can be initiated.

According to some embodiments, the receiving devices on the wireless mesh network of the network node can respond to the transmitting device with the requested information and optionally lock their ability to charge (i.e., prevent a user from logging in to the receiving device to initiate a charging session) after reporting the information. In some embodiments, the option for a receiving device to lock its ability to charge depends on the node's instant capacity compared to the MCP limit. For example, if the node's capacity is close to the MCP limit, the receiving device may option to lock its ability to charge while or after reporting the requested information to the triggered device via the network node.

Finally, the triggered device may determine whether it can initiate a charging session as soon as it receives sufficient information to proceed (i.e., determines the status of the unknown and known devices) via the network node. When the triggered device initiates a charging session, it notifies the other devices connected to the network node of its status, and sends a release broadcast for that transaction allowing other devices to access their charging function, according to operation 210.

According to some embodiments, a receiving device connected to the network node may continuously check for messages over the wireless mesh network of the network node. According to some implementations, when a device receives a message, such as the message transmitted by a triggered device, it can broadcast the following information: i) an acknowledgement that a message with a specific ID, such the one transmitted by the triggered device, has been received; ii) a corresponding timestamp; iii) its charging status; iv) its priority status indicating whether it has priority over the transmitting device; and v) its node number that corresponds to the order that the device is commissioned.

As discussed above, when a receiving device is in standby mode and receives a message, it would not allow a user to log in to the device to initiate a charging session. However, since the receiving and replying processes take a short period of time (e.g., a couple of seconds), it should not substantially impact the transmitting device's operation or substantially delay a response to a user's input.

### D. Communication Configurations

As discussed above, the system disclosed herein relies on the network node, which utilizes an offline wireless mesh network and an online server system, to ensure uninterrupted communication between devices within one or more electrical nodes under a wide range of operational conditions. This operation provides superior operational stability and functionality as discussed in more detail below.

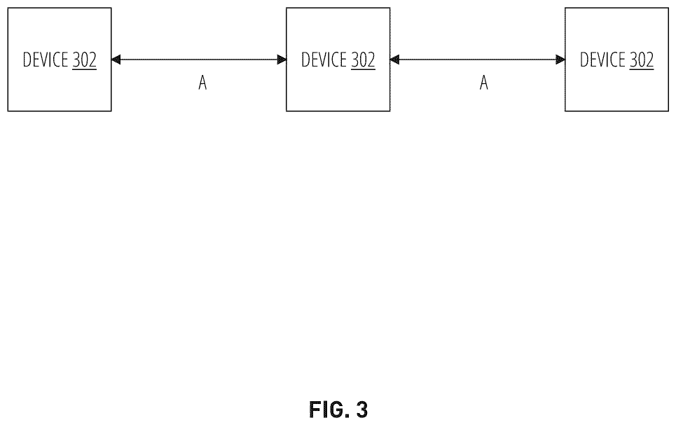

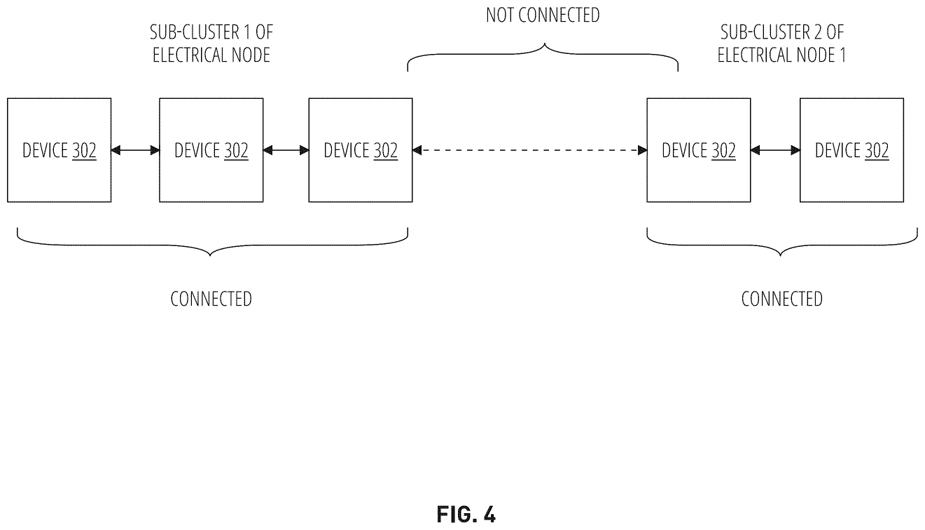

In a simple scenario shown in FIG. 3, where devices 302 in a node are connected only via the wireless mesh network of network node, the amount of time required to communicate between devices with line-of-sight visibility will be far shorter than the time required for the devices to communicate with a server system in which the server may be located, for example, halfway around the world. However, when accounting for variances in the electrical node configuration, one could run into the exemplary scenario shown in FIG. 4, where although devices 302 in the sub-cluster 1 of an electrical node are communicatively coupled to each other by virtue of being in a line-of-sight arrangement, they may be unable to connect to devices 302 in a sub-cluster 2 of the electrical node because there is no line-of-sight visibility between the two clusters. In the example of FIG. 4, if the (MCP-i_{uncounted for}) exceeds the max current draw for the devices of one sub-cluster, charging may not commence for the devices of that sub-cluster, which is an unfavorable condition.

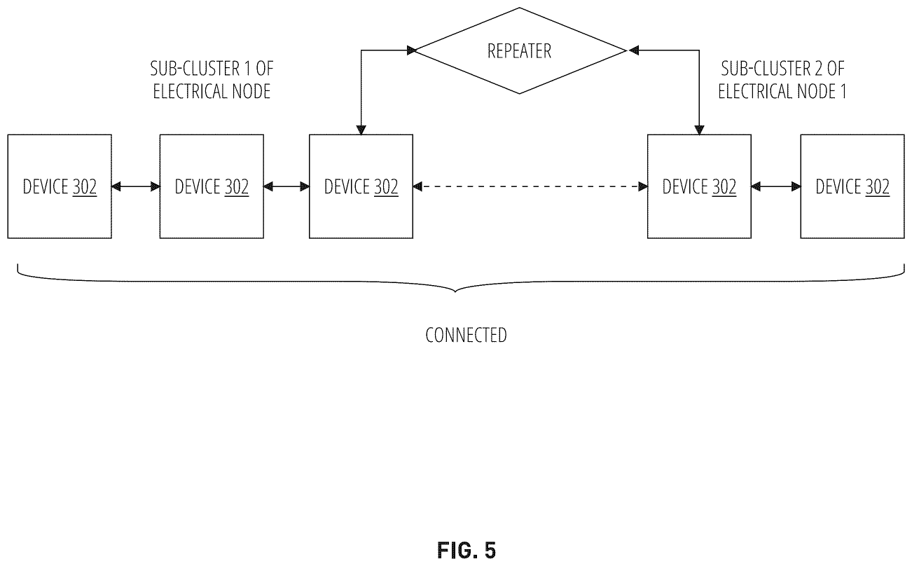

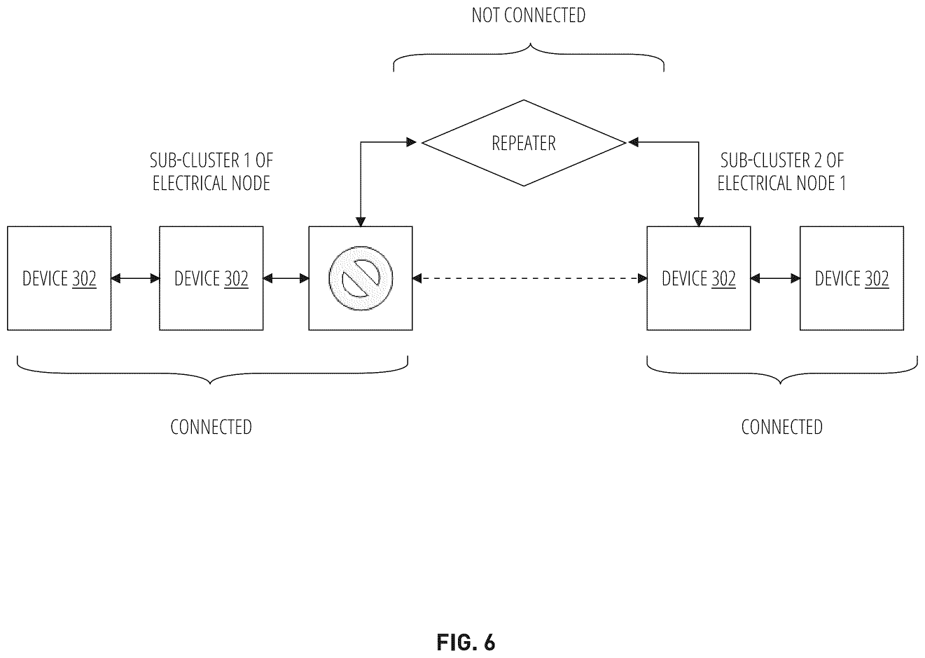

This may be addressed by adding “a repeater” between sub-clusters 1 and 2 to bridge the connection gap, as shown in FIG. 5. However, this solution has its challenges. For example, if one of the devices 302 which connects to the repeater becomes unresponsive, then the two sub-clusters may again disconnect, as shown in FIG. 6. This situation can be addressed by introducing internet connectivity via the server system of the network node as discussed in reference to FIG. 1.

Therefore, implementing both a wireless mesh network and a server system in a network node creates a system redundancy suitable for a variety of deployment conditions.

### II. Modular Vehicle Charging Stations for Vehicle Charging Networks

According to some embodiments, the method and system disclosed herein enable a third party entity to effortlessly install and maintain one or more charging systems, such as EV charging stations, within an existing electrical infrastructure without requiring any participation from the owner of the electrical infrastructure. This arrangement can be beneficial for both parties, the end user and the owner of the electrical infrastructure, because it (i) relieves the electrical infrastructure owner from the charger installation process, which involves the use of a dedicated external electrical network that increases the ownership and operational cost; and (ii) reduces the wait time for the end user. According to some embodiments, when a third party entity owns the EV charger and is responsible for the maintenance and installation process of the EV charger, EV chargers may become quickly available for use. At the same time, revenue generated through the quick charger deployment, can expedite the return of investment (ROI) for the end user.

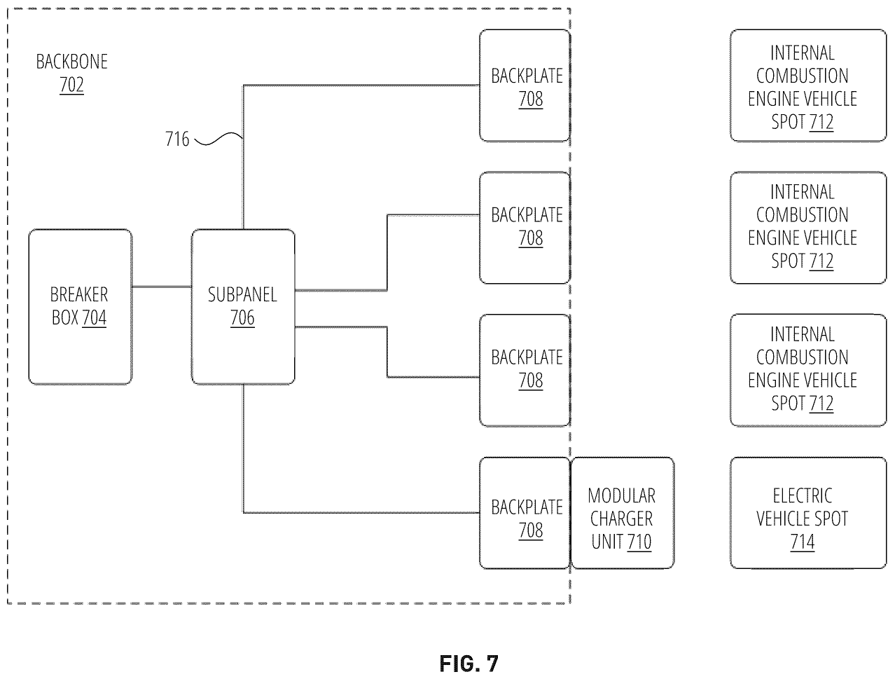

To achieve the aforementioned benefits, the system disclosed herein features a modular EV charger design, according to some embodiments. The modular EV charger, thereafter referred to herein as modular charger unit, can be installed onto a backplate connector of an existing electrical backbone infrastructure that may include a breaker box, a subpanel, a charger backplate, and the copper wiring or be connected to the main breaker of an apartment unit via an energy management system (EMS) described further below. By way of example and not limitation, FIG. 7 is a schematic diagram of such an exemplary configuration, according to some embodiments. As shown in FIG. 7, an existing electrical backbone infrastructure 702 (thereafter backbone 702) includes at least a breaker box 704, a subpanel 706, one or more backplates 708, and copper wiring 716 electrically connecting all these elements together. When the end user wants to convert an internal combustion engine vehicle spot 712 to an electric vehicle spot 714, he/she may simply attach a modular charger unit 710 to a backplate 708 that is the closest to the electric vehicle spot 714 of interest, according to some embodiments.

In this context, the charger backplate refers to a mechanical mounting plate for the modular charger unit 710. By way of example and not limitation, the backplate may feature an electrical 240 Volts alternating current (AC) wiring (e.g., the copper wiring 716) terminating to a covered connector, such as a Phoenix Connector 1913523 (TERM BLOCK PLUG 4POS STR 10.16MM). Each backplate 708 can be connected to the subpanel 706, which is in turn connected to the circuit breaker box 704.

In some embodiments, the backbone 702, may have no digital electronic components that degrade over time. The use of the backplate configuration as disclosed herein allows electrical infrastructure owners (e.g., property owners or businesses) to display electric vehicle (EV) readiness with minimal upfront investment, and the end-users (e.g., the tenants, residents, or business customers) to be assured that they can have a place to charge their vehicle when they decide to switch from an internal combustion engine vehicle to an EV. At the same time, a third party company, which may, for example, own the maintenance and deployment of the modular charger units, does not have to be concerned with asset degradation in the field while a vehicle does not utilize the modular charger units or generates revenue. Once the installation of the backbone is complete, the electrical infrastructure owners are no longer concerned with the installation of additional parts, the maintenance of the electrical backbone, or the operation of the modular charger unit 710.

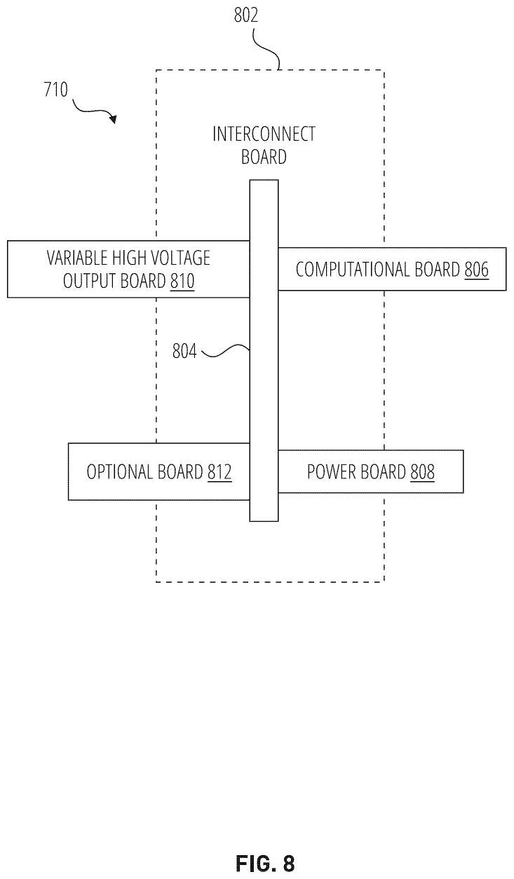

According to some embodiments, FIG. 8 is a schematic diagram of the modular internal components in modular charger unit 710 shown in FIG. 7. In some embodiments, the modular charger unit 710 includes an external housing 802, which in turn contains an internal interconnect board 804 that features slots configured to receive removable modular boards in the form of individual cartridges that may be inserted to respective openings in the housing 802 to electrically couple and mechanically secure the removable boards directly onto the interconnect board 804, as shown schematically in FIG. 8. According to some embodiments, the modular boards can be inserted and removed independently from the charger's housing 802 when, for example, a modular board needs to be replaced. Each of the receiving slots on the interconnect board 804 can feature suitable electrical connection receptacles to integrate the modular boards when inserted to the interconnect board 804 of the modular charger unit 710.

As depicted in FIG. 8, the modular boards can include a computational board 806, a power board 808, a variable high voltage output board 810, and an optional board 812, according to some embodiments. In further embodiments, the computational board 806 is configured to provide all the communications and calculations on the modular charger unit 710; the power board 808 is configured to provide power monitoring, power controls, and direct current (DC) power supply to the modular charger unit 710; and the variable high voltage output board 810 is configured to receive data signals and power, and to provide suitable output to charging systems of a connected EV.

In some embodiments, all the modular boards (the computational board 806, the power board 808, and the variable high voltage output board 810), except for the interconnect board 804, can be installed and uninstalled from the modular charger unit 710 by a non-technical person, such as an end user. It is noted that installation or removal of the modular boards on modular charger unit 710 does not require a person to remove the modular charger unit 710 from the backplate 708. However, when the interconnect board 804 needs to be replaced, the modular charger unit 710 may be removed from the backplate mount by disconnecting any ingress cables connecting the backplate 708 to the modular charger unit 710, and replacing the entire modular charger unit 710 with a new one.

In some embodiments, the modular charger unit 710 may be equipped with an optional board 812. The optional board 812, which may have access to the 120 Volts AC power of the interconnect board 804, can provide additional functionality to the modular charger unit 710, according to some embodiments. For example and without limitation, the optional board 812 may be a simple 120 Volt AC output adapter or be a board with some other functionality, such as environmental monitoring functionality. In some embodiments, the optional board 812 may be configured to connect wirelessly with other modular charger units over a wireless mesh network of a network node and/or the internet via a message queue telemetry transport (MQTT) protocol.

In some embodiments, the variable high voltage output board 810 may include an appropriate female socket (e.g., a Mennekes Type 2 socket) so that a charging gable of an EV may be connected to the modular charger unit 710.

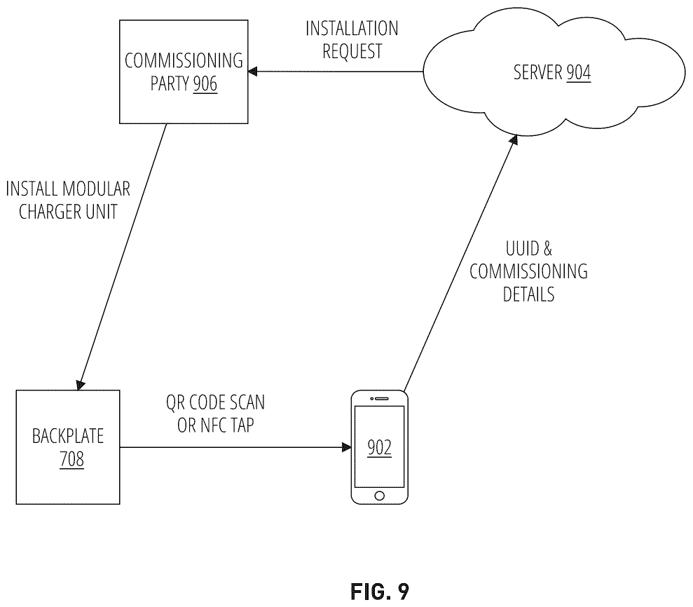

According to some embodiments, FIG. 9 schematically describes an exemplary commissioning process for modular charger unit 710, according to some embodiments. By way of example and not limitation, a quick-response (QR) code or a near field communication (NFC) tag may be disposed on each backplate 708. When a user scans the QR code or interacts with the NFC tag (e.g., taps on the NFC tag) located on the backplate via an appropriate user device 902, such as a smartphone or another device), he/she may be directed to a commissioning website running, for example, on a remote server 904. In some implementations, the QR code or NFC tag may contain location and/or UUID information of backplate 708, which can be automatically uploaded to server 904 when the user scans the QR code or interacts with the NFC tag. This information allows server 904 to determine the installation location of the modular charger unit, and collect any user information that is relevant to the installation process. The user may then be prompted to complete a questionnaire about their EV type, charging requirements and desired options to minimize any false deployments. By way of example, this information can be uploaded via server 904 to a database (not shown).

Once the user completes the questionnaire and all the information is gathered, the server 904 may send an installation request to a commissioning party 906, which can review the request, prepare the order, and dispatch a technician to install the modular charger unit at the requested backbone and/or backplate location. In some embodiments, the modular charger unit may be sent directly by the commissioning party 906 to the user who will be responsible for the installation process.

According to some embodiments, the modular charger unit can be mechanically attached and secured, via appropriate fasteners, to the backplate so that it is electrically coupled to the covered connector of the backplate. In some embodiments, the modular charger unit can be commissioned by the technician once the modular charger unit has been secured on and electrically coupled to the backplate of the backbone. Because there are no exposed wires on the backplate, the installation process of the modular charger unit is as simple as plugging in an electrical appliance to an outlet.

Advantageously, this backplate-modular charger unit configuration provides the ability to remove and retrieve the modular charger unit when it is no longer needed—e.g., when the EV parking space is no longer in use. Recovering the modular charger unit from the field (e.g., either by having the user mail the modular charger unit or drop it to a collection center) allows the commissioning party 906 responsible for the unit's deployment/commission to refurbish and test the modular charger unit before redeploying it to a different location. This approach reduces the capital expenditures for the commissioning party 906.

### III. Modular Energy Distribution and Load Management System

The goal of the disclosed modular energy distribution and load management system, thereafter referred to herein as energy management system (EMS) or system for simplicity, is to promote the adoption of green energy technologies within multi-unit apartment complexes by avoiding expensive upgrades to upstream breaker boxes, service lines, and/or transformers. According to some embodiments, the disclosed EMS can efficiently manage the power delivered to an end service panel and/or to a high current application (HCA), such as an EV modular charger unit or a regular EV charger unit, by leveraging the existing electrical infrastructure, and thus, eliminating the need for costly upgrades. Advantageously, the disclosed system is not limited to residential applications and may be implemented to any power generation, storage, and distribution system, such as renewable energy production and distribution systems. For example purposes, the EMS concept will be described in the context of residential applications, and more specifically, how the EMS concept can achieve energy distribution and load management in multi-unit apartment complexes. However, as mentioned above, this is not limiting, and the EMS concept as described herein may also be used with any other system that requires energy distribution and load management functionality, as would be understood by a skilled artisan.

According to some embodiments, the EMS is a modular unit that features cartridges that can be installed and replaced quickly for repair and upgrades. This allows non-technical personnel to repair and maintain the system. Advantageously, implementation of the EMS, as disclosed herein, can address the shortage of technical personnel, such as certified electricians, required for general maintenance and installation of green infrastructure.

In some implementations, an EMS unit features two primary types of cartridges. The first type of cartridge is a communication cartridge configured to operate as a communication hub between connected HCAs via a Long Range (LoRa) wireless communication network. The second type of cartridge is a power cartridge configured to monitor power consumption from an apartment's electrical system. In some implementations, the second cartridge(s) can report the monitored power consumption value to the communication cartridge, and quickly shut off power to a connected HCA when the monitored power from an apartment and/or the HCA exceed an electrical limit at a rate that is too fast for the HCA (e.g., an EV charger) to react. Additionally the second cartridge(s) can act as electrical islanding during power outage events.

More specifically, the disclosed EMS unit is a modular unit with a housing equipped with a series of slots configured to receive a communication cartridge and one or more power cartridges, with each power cartridge being dedicated to an apartment in a multi-unit apartment complex. In some embodiments, the EMS unit can also feature disconnect switches configured to divert power to a selected pathway when a power cartridge is installed.

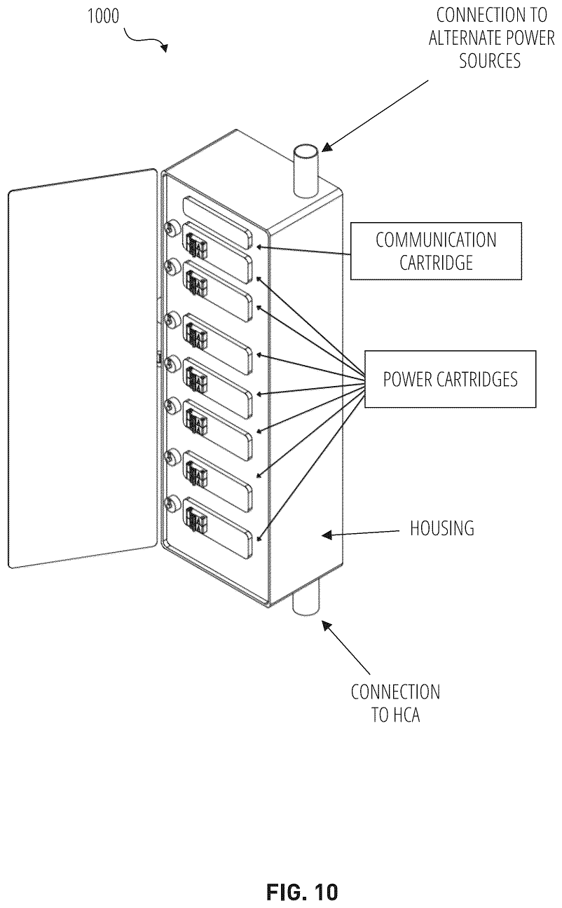

By way of example and not limitation, FIG. 10 is an isometric view of an exemplary EMS unit 1000. As discussed above and shown in FIG. 10, EMS unit 1000 is a modular unit having a housing that features slots for one removable communication cartridge and several removable power cartridges (e.g., in this instance, seven power cartridges). Accordingly, the EMS unit 1000, as shown in FIG. 10, can provide energy distribution and load management for up to seven apartments. Because the cartridge system of EMS unit 1000 has a modular design, it can separate the communication and power monitoring/splitting subsystems into separate cartridges.

Besides its connection to the grid via each apartment's breaker box, the EMS unit 1000 may be electrically coupled to alternative energy sources, such as solar inverters and battery systems (not shown), via its power cartridges over an AC bus. Additionally, EMS unit 1000 can include electrical connections to one or more HCAs, such as EV charging stations (e.g., modular charger units). Although not shown in FIG. 10, EMS unit 1000 can include additional electrical connections to the master breakers and subpanels of the apartments it connects to. Specifically, the EMS unit 1000 can be configured to monitor the power output between a master breaker and subpanel for one or more apartments in a multi-unit apartment complex, and send signals to the HCA (e.g., via the LoRa wireless communication network) about the maximum amount of power left in the circuit that is below the 80% circuit utilization, as required by the national electrical code.

In some implementations, EMS unit 1000 can be a variable load system configured to send to the HCA (via the LoRa wireless communication network) a signal regarding the maximum power that can be drawn by the HCA at any given time. In some embodiments, the HCA may be equipped with an internal timer which can time out when the EMS unit does not send out a new maximum power draw within an allotted time period. When the system times out, the HCA may default to a lower specified continuous load draw, according to some embodiments. The disclosed EMS unit may also be configured to dynamically reduce the lower specified continuous load when the circuit utilization is high, according to some embodiments.

In some embodiments, EMS unit 1000 can be equipped with a small battery (not shown) to prevent communication and microcontroller operation disruptions in emergency situations, such as during power outages.

In additional embodiments, each power cartridge of EMS unit 1000 may include an automatic transfer switch (ATS) (not shown in FIG. 10) configured to automatically electrically isolate or “island” the HCA, the battery and/or solar systems (if connected to the EMS unit), and the tenant's residence from the grid during a power outage. According to some embodiments, when electrical isolation occurs and the ATS is triggered, the EMS unit can be configure to alert an HCA (such as an EV modular charger unit like the modular charger unit 710 shown in FIG. 8) that it is safe to back feed power to the tenant's residence via the tenant's own EV that is connected to the EMS unit via the HCA (i.e., the EV charger). In other words, the EMS unit can be configured to enable EV vehicle-to-apartment power transfer under a power outage scenario.

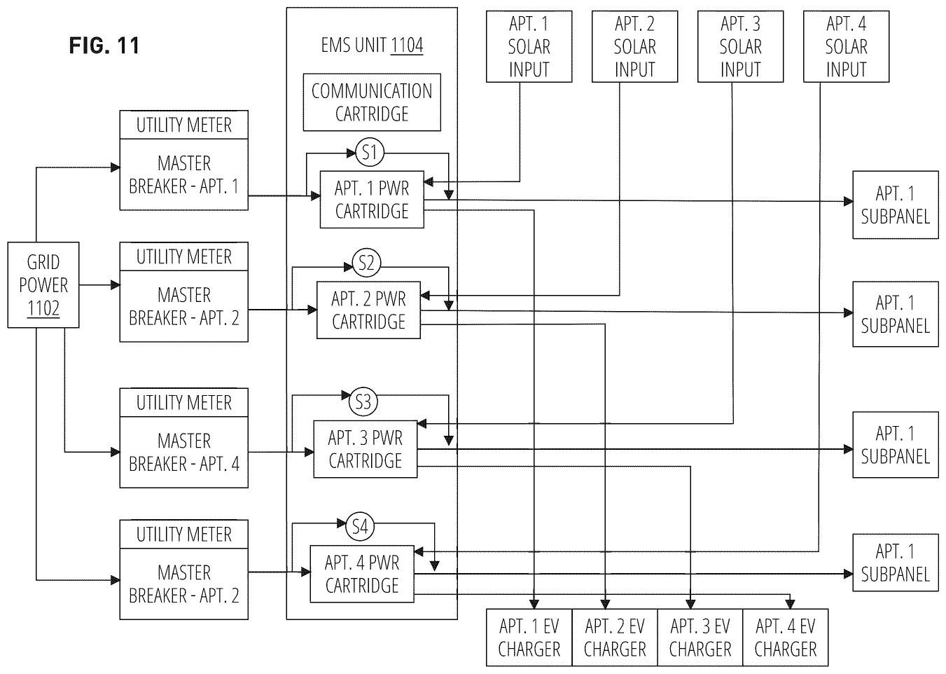

According to some embodiments, FIG. 11 is a block diagram of an exemplary electrical wiring for an EMS unit 1104 in a four-unit apartment setting. It is noted that EMS unit 1104 is similar to EMS unit 1000 with the exception that EMS unit 1104 is equipped with fewer power cartridges compared to the EMS unit 1000 (i.e., four instead of seven).

As shown in FIG. 11, each power cartridge is connected to grid power 1102 via a respective apartment master breaker. For instance, the power cartridge for apartment 1 (APT. 1 PWR CARTRIDGE) is electrically coupled to grid power 1102 via the apartment's master breaker (MASTER BREAKER-APT. 1), and so on. Further, the subpanel of apartment 1 is connected to the apartment's master breaker via the corresponding power cartridge in EMS unit 1104. For instance, the subpanel of apartment 1 (APT. 1 SUBPANEL) is electrically connected to the apartment's master breaker (MASTER BREAKER-APT. 1) via the respective power cartridge of EMS unit 1104 (APT. 1 PWR CARTRIDGE), and so on. Thus, EMS unit 1104 is configured to be electrically interposed between the master breaker and subpanel of an apartment. This wiring configuration allows EMS unit 1104 to monitor and control the power output from the master breakers to the subpanels for each apartment to which the EMS unit 1104 is connected.

Additionally, each power cartridge in EMS unit 1104 is electrically connected to a corresponding HCA, such an EV charger. For example, if a tenant (or the tenants) in apartment 1 owns a dedicated EV charger in the apartment complex, the power cartridge for apartment 1 (APT. 1 PWR CARTRIDGE) can be electrically coupled to the tenant's charger (APT. 1 EV CHARGER), and so on. This allows EMS unit 1104 to shut OFF the EV charger when required and/or receive power from the EV charger during a power outage. In some embodiments, the power cartridge, which is configured to monitor power consumption from an apartment's electrical system, reports the monitored power consumption value to the communication cartridge, which in turn communicates to a coupled EV charger, via a LoRa wireless communication network, information about the maximum amount of power left in the circuit and/or the maximum power that can be drawn by the EV charger at any given time. In other words, information related to the power consumption are gathered by the power cartridges of the EMS unit and are communicated to the communication cartridge, which in turn relays the information to the HCA (i.e., the EV charger or modular charger unit) via a LoRa wireless communication network.

As discussed above an EMS unit may also be connected to optional secondary sources of energy, such as renewable sources of energy, battery packs, and the like. For instance, if an apartment is connected to a secondary source of power, such as a solar panel, the power cartridge of EMS unit 1104 corresponding to that apartment may be wired to receive power from a respective solar inverter for that solar panel. Thus, in the example of FIG. 11, the power cartridge for apartment 1 (APT. 1 PWR CARTRIDGE) can receive power from the solar inverter of apartment 1 (APT. 1 SOLAR INPUT), and so on. This configuration enables EMS unit 1104 to distribute the power from other potential energy sources, if available, beyond the power received from the grid.

In further embodiments, each power cartridge in EMS unit 1104 is equipped with an optional Automatic Transfer Switch (ATS) (not shown in FIG. 11) that is configured to automatically electrically isolate or “island” the EV charger, the solar inverter, and the subpanels of an apartment during a power outage, and to allow electrical power from the EV charger to flow back to the apartment's subpanel via the tenant's EV, if the tenant's EV is connected to the charger. In other words, EMS unit 1104 can enable vehicle-to-apartment power transfer under a grid power outage scenario via the function of the ATS. For example, when EMS unit 1104 senses that the there is no power to the master breaker of apartment 1 (MASTER BREAKER-APT. 1), the ATS of the the unit's power cartridge (APT. 1 PWR CARTRIDGE) is automatically triggered, and the EMS unit 1104 can request from the EV charger of apartment 1 (APT. 1 EV CHARGER) to provide power to the apartment's subpanel (APT. 1 SUBPANEL) via the unit's power cartridge (APT. 1 PWR CARTRIDGE) if the tenant's EV is connected to the charger.

In some embodiments, each power cartridge of EMS unit 1104 can be equipped with a relay (not shown) configured to TURN OFF the power flow to an EV charger whose energy consumption suddenly spikes. This configuration can advantageously prevent the apartment's master breaker from being overloaded and surpasses the LoRa network's reaction time, given the charger's sudden current consumption. In some embodiments, the relay allows the EMS unit 1104 to respond to less than 20 ms, which is a breaker's typical response time to an overload incident. In some embodiments, the relay and the LoRa network information may be transmitted via telemetry to back-end machine learning algorithms, which can be trained to predict high load situations. Using this information, the operation of the EMS unit can be optimized to predict high load incidents and use LoRa proactively instead of engaging the relay and shutting off the EV charger.

In further embodiments, the EMS unit is equipped with switch disconnects S1-S4 configured to allow power to flow directly between the apartment's master breaker and subpanel when a power cartridge is not installed in the EMS unit 1104 for that apartment, as discussed below.

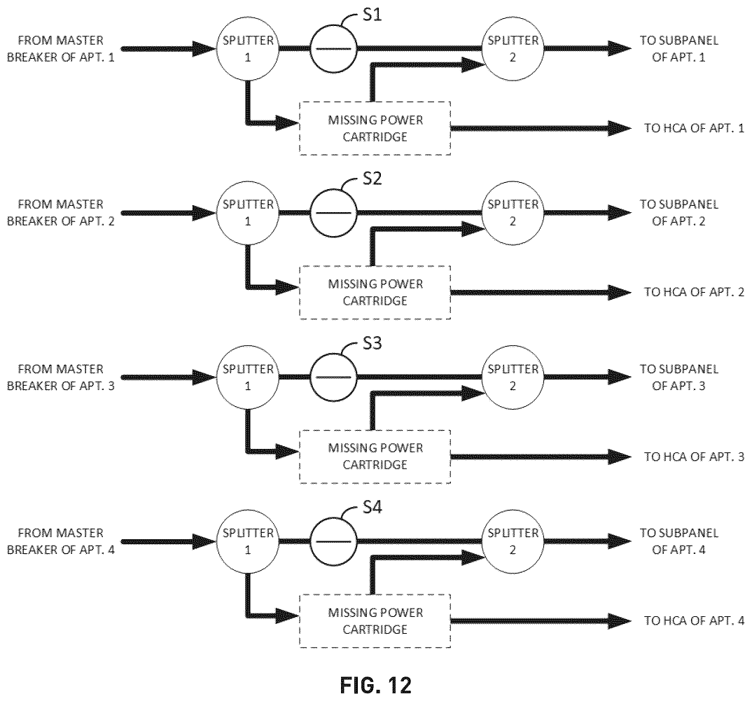

According to some embodiments, FIG. 12 is a schematic diagram of an exemplary electrical configuration within the EMS unit 1104 when the EMS unit 1104 has no power cartridges installed, as indicated by the dashed line boxes. As shown in FIG. 12, when switch disconnects S1-S4 are in a “closed” position, power can flow through an uninterrupted path for each apartment from the apartments' master breaker to respective subpanels, via internal (to the EMS unit) splitters 1 and 2. It is noted however that because there are no power cartridges installed in this configuration, current has no path to an HCA, such as an EV charger. That is, the HCA is not electrically connected to the apartments.

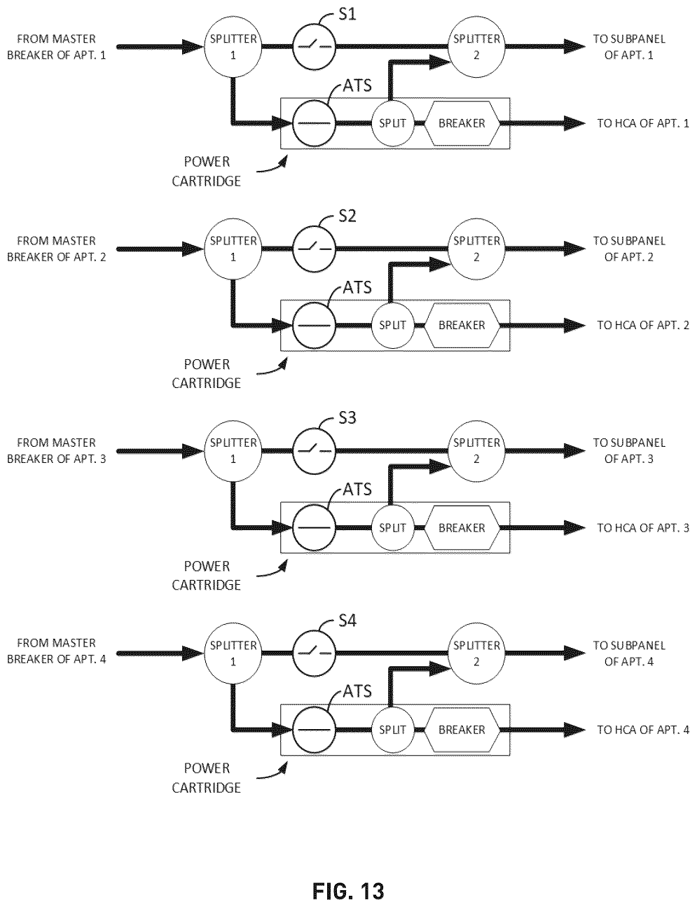

According to some embodiments, FIG. 13 is a schematic diagram of an exemplary electrical configuration within the EMS unit 1104 when the power cartridges for all the apartments are installed. In this configuration, power from each apartment's master breaker can flow through the ATS of the power cartridge, and subsequently split towards the subpanel of the apartment and a corresponding HCA, such as an EV station. It is noted that in this configuration, the switch disconnects S1-S4 are now in an “open” position forcing the current to flow through the installed power cartridge of the EMS unit. In some implementations, each power cartridge includes a dedicated circuit breaker that can be disposed upstream of the HCA between the ATS and the HCA so that the power split may occur prior to reaching the dedicated circuit breaker and the HCA.

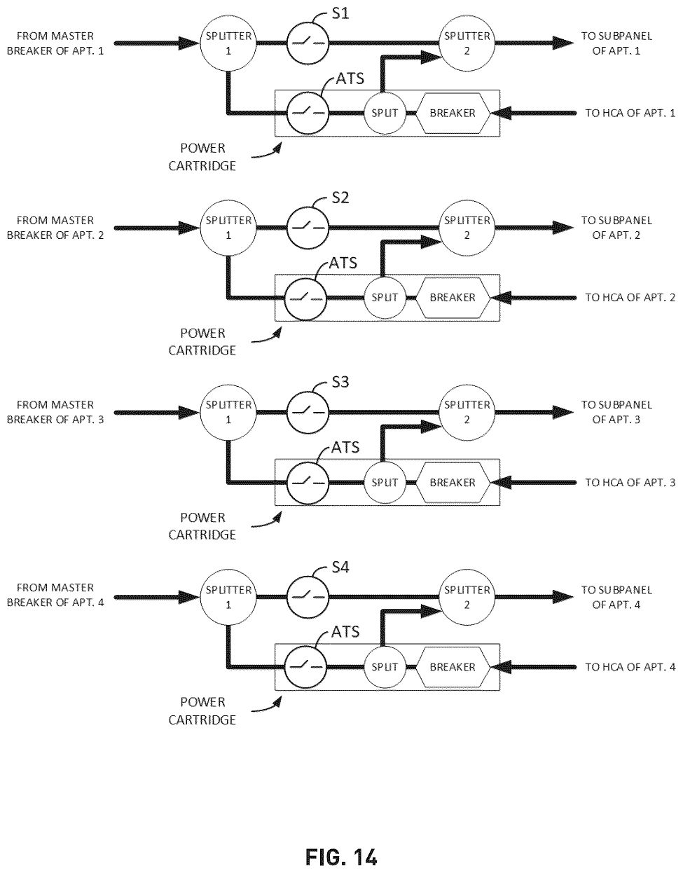

According to some embodiments, FIG. 14 shows the schematic diagram of FIG. 13 during a power outage scenario. In this situation, all the ATS automatically open the circuit so that the subpanel in each apartment is electrically isolated from its respective master breaker (i.e., the grid), which enables power from the HCA (i.e., the EV charger) to flow via the power cartridge towards the apartment's subpanels. It is noted however that power from the EV charger may only be delivered when a charged EV is connected to the apartment's EV charger, which in this instance the EV acts as a battery storage unit.

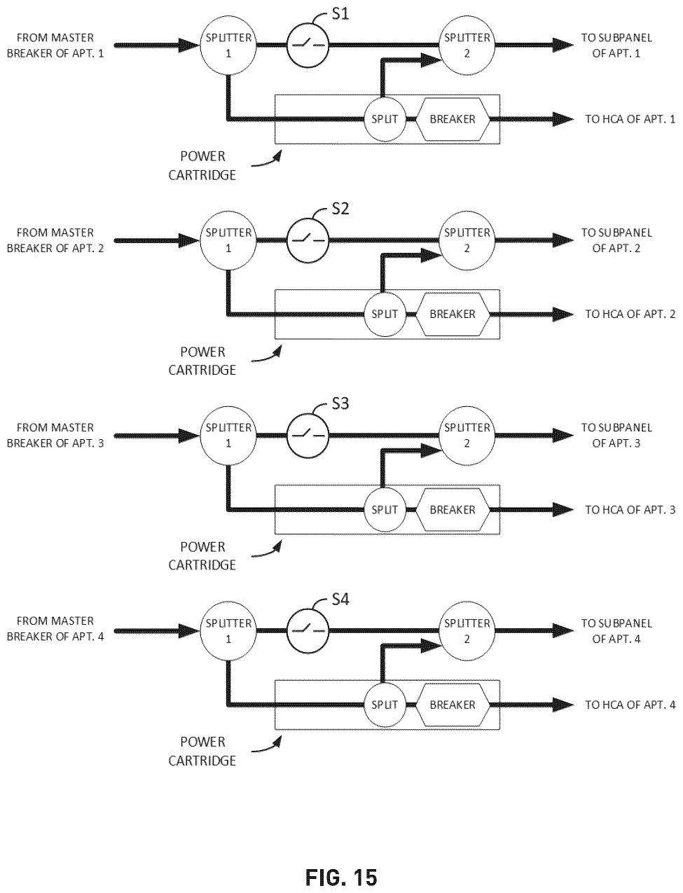

In some embodiments, if powering the apartment units from charged EV is not desirable during power outages, the power cartridge may be optioned without the ATS as shown in FIG. 15. In the example of FIG. 15, the power cartridge merely splits and monitors the power going to each apartment's subpanel, while allowing electric power to flow to a connected HCA.

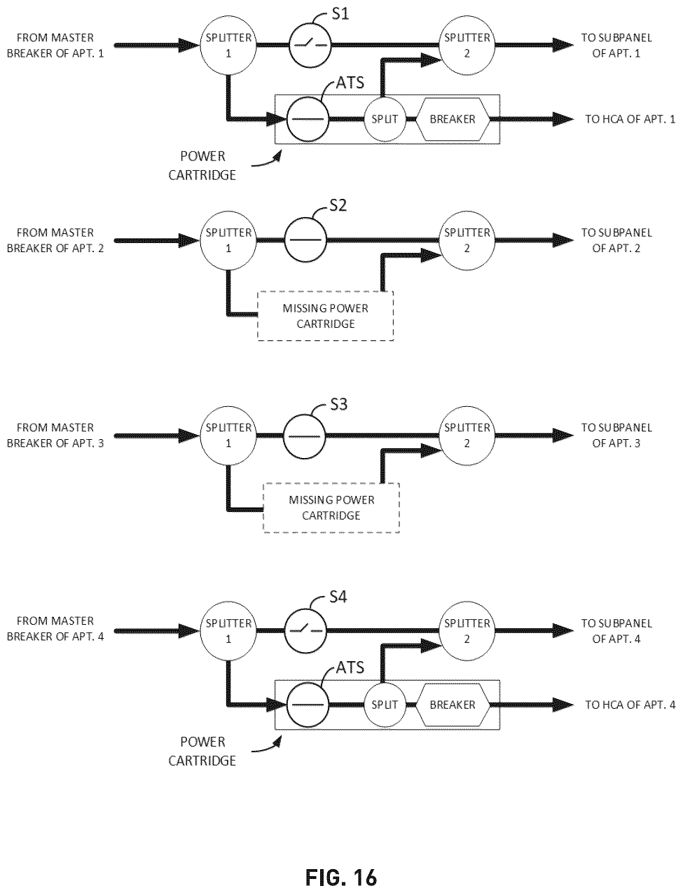

According to some embodiments, FIG. 16 is a schematic diagram of yet another alternative electrical configuration within the EMS unit 1104 referred to as a switchboard configuration. In this configuration, master breakers of selected apartment units (e.g., apartments 1 and 4) are connected to power cartridges with optional ATSs because perhaps only the residents or tenants of these apartments have EVs that need access to HCAs, such as EV chargers. At the same time, residents of apartments 2 and 3 may not need access to an EV charger. The EMS unit 1104 can be configured to accommodate this scenario, which may change in the future when the tenants of apartment 2 and 3 need access to an EV charger, or perhaps when the tenants in apartments 1 and 4 no longer need access to an EV charger.

When a limited number of EV chargers are available for the apartments to share, and thus, an one-to-one assignment is not an option, the power cartridge of the EMS unit can be configured to act as a selector that diverts an apartment's power to an available HCA, such as an EV charger. To achieve this, the power cartridge can be equipped with appropriate HCA connectors inserted in suitable slots on the power cartridge, according to some embodiments. In this context, it is the slot position of the HCA connector that determines which apartment will be connected to which HCA.

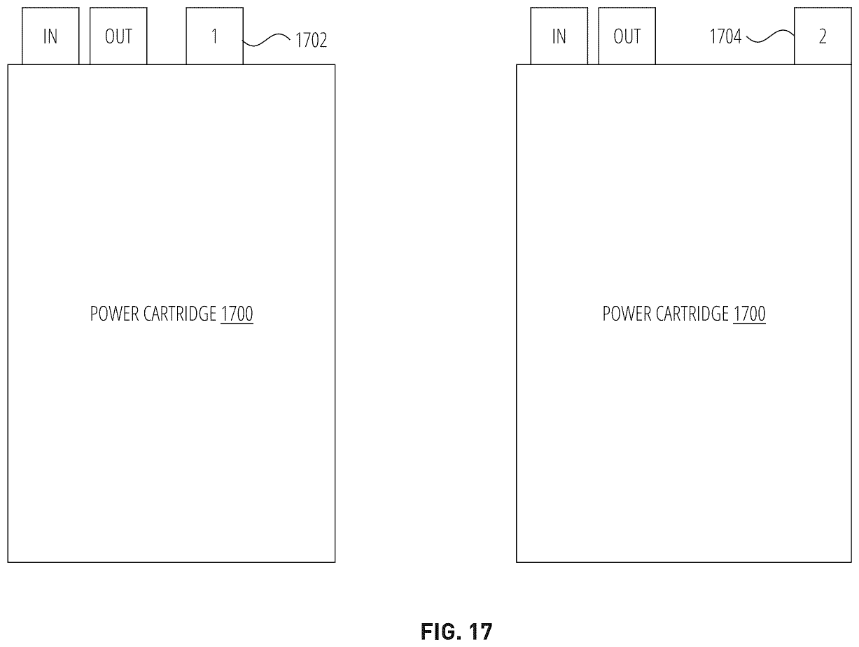

According to some embodiments, FIG. 17 shows an exemplary power cartridge 1700 with two HCA position connectors. As a non-limiting example, a first connector 1702 in position 1 may correspond to an EV charger in a first spot of an apartment complex, and a connector 1704 in position 2 may correspond to another EV charger in a second spot of the apartment complex. It is noted that the power cartridge 1700 may be configured to include additional HCA positions to receive respective connectors. By positioning each HCA connector to a slot in the power cartridge 1700 between positions 1 and 2, a user may be able to select which EV charger to use—i.e., which EV charger can be connected to his/her apartment.

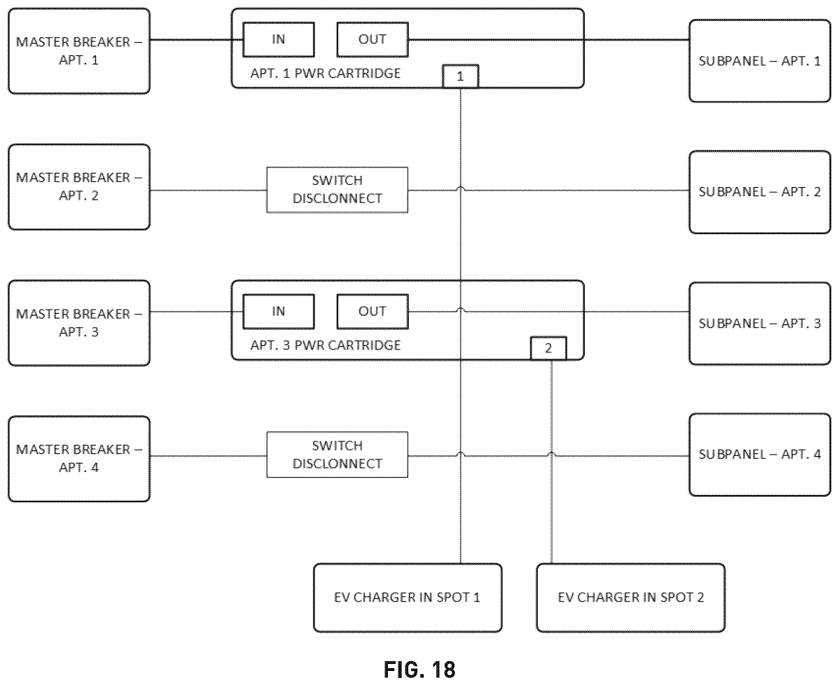

According to some embodiments, FIG. 18 shows an exemplary wiring configuration of four units with only two EV chargers in hypothetical spots 1 and 2. In this exemplary wiring configuration, which resembles the configuration shown in FIG. 16, if a resident/tenant in apartment 1 wishes to access the EV charger in spot 1 and a resident/tenant in apartment 3 wishes to use the EV charger in spot 2, the tenants or an installer can install in the EMS unit power cartridges with respective HCA connectors in appropriate positions for their apartments. For example, the resident/tenant of apartment 1 can insert an HCA connector in position 1 of his/her corresponding power cartridge, which enables a connection to the EV charger in spot 1. Similarly, the resident/tenant of apartment 3, can insert another HCA connector in position 2, which enables a connection to the EV charger in spot 2. Resident/tenants of apartments 2 and 4, who do need access to the EV chargers in spots 1 and 2, may option not to use power cartridges for their apartments.

It is to be appreciated that the scenario described in FIGS. 11-18 may be scaled to any number of apartments and/or available EV charging spots.

In an alternative embodiment, the physical components within the EMS unit may be configured differently. For instance, a common communication board and backplate can be installed for one or more power monitoring backplates and boards. In such configuration, each power monitoring backplate can be communicatively coupled with the communication board, which would contain the LoRa wireless communication network components that enable communications between the EMS and the EV charger(s) via, for example, a Bluetooth® mesh network, Wi-Fi mesh network, or via a direct controller area network (CAN) wiring. It is to be appreciated that besides the presence of an optional CAN wiring, the power monitoring boards and backplates and the communication board and backplate can be physically isolated from each other.

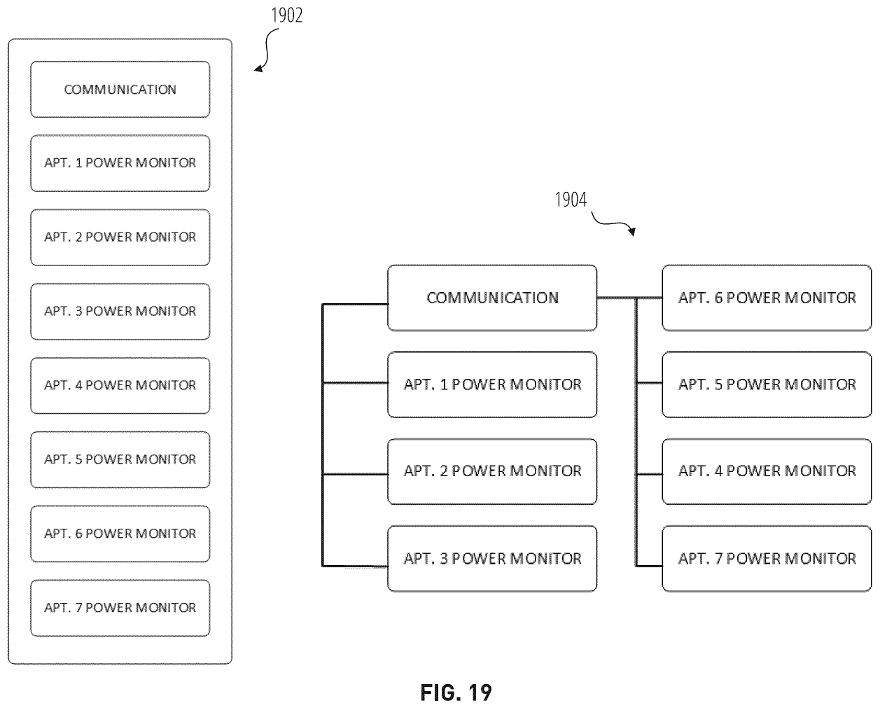

Advantageously, in this alternative configuration, the number of monitor backplates can dynamically scale to the exact number of available EV charging spots, as opposed to an EMS unit discussed above, which can have a fixed number of available slot-cartridge combinations for respective apartments. By way of example and not limitation, FIG. 19 shows the two possible EMS configurations 1902 and 1904. Configuration 1902, is the configuration of the modular EMS unit discussed in connection to FIG. 10, which may have a fixed number of slots for respective power cartridges and apartments. On the other hand, configuration 1904 is a flexible modular configuration based, for example, on a CAN wiring scheme. As discussed above, configuration 1904 may dynamically scale to the exact number of available EV charging spots by adding or subtracting monitor backplates according to the number of available EV chargers. Without limitation, configuration 1904 can be implemented similarly to configuration 1902 (e.g., in FIGS. 11-16, and 18).

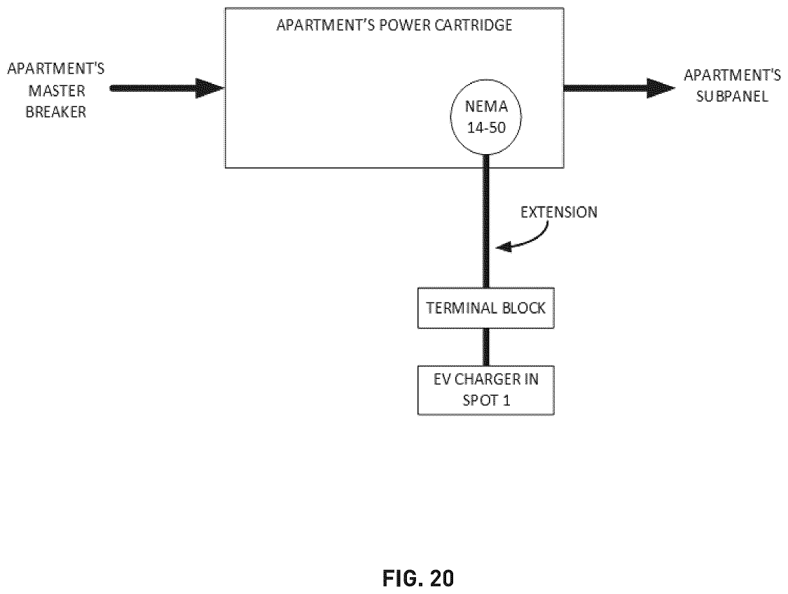

In configuration 1904, the outgoing HCA connection can be hardwired, if there is a one-to-one spot-to-apartment use case, or connected to the power (monitoring) cartridge via a suitable connector (e.g., a NEMA 14-50 plug), to allow reconfiguration of the spot-to-apartment power mapping without requiring high-skilled labor (e.g., a certified electrician). This is shown schematically in FIG. 20. By way of example and not limitation, each of the connectors can be labeled to correspond to a specific spot number based, for example, on a color-code labeling system to avoid confusion in future modifications.

In further embodiments, rather than attaching an EV charger to a backplate (as shown in FIG. 7), EV charging can be deployed with a standard outlet (NEMA 5-15 or higher depending on the subpanel layout) as an alternative to an actual EV charger unit. To achieve this, the outlet can be installed in parallel with a “dummy power monitoring cartridge” at the EMS unit to route the power from the appropriate apartment. According to some embodiments, the “dummy power monitoring cartridge” will not monitor power consumption. Rather, it would bridge the gap between the input power from the apartment complex (that would otherwise be used for the EV charger) to the egress selector circuit, which would be connected to a specific spot in the parking lot.

A. Commissioning the EMS with a Modular Charger Unit

According to some embodiments, to commission the EMS, the installer (e.g., the end user or a technician) can use a combination of manual measurements and photos to document the electrical wiring, the state of the meter bank, and information about the apartments main breakers. This includes, but is not limited to, the breaker's amperage rating, the type of breaker, the type of meter, the quantity of breakers, and the like. This process can be done via a provided device application running on a smart device, such as a smartphone, a tablet, and the like. The application can collect and upload all the information to a server for processing. Based on the information collected, the server can prepare a configuration file, which can be downloaded to the installer's device (e.g., to the installer's smartphone device).

Once the installer has installed the backplate for the EMS, the installer can use the downloaded configuration file as described below. In this context, the backplate is the equivalent of a breaker box without the breakers—i.e., the EMS core without any of the cartridges installed. Next, the installer can install a “commissioning” communications cartridge to the backplate (i.e., to the EMS core). According to some embodiments, when the commissioning communications cartridge is powered, it will start broadcasting a Bluetooth signal, which, when the installer's device is moved close to the cartridge, the installer's device will automatically connect and begin transferring the configuration file to the commissioning communications cartridge. The commissioning cartridge will then store this information (as well as any encryption information, LoRa operating frequency information, etc.) in the EMS communications backplate on an onboard storage medium, such as an I2C EEPROM. The commissioning communications cartridge can then be removed from the backplate once it has indicated that the transfer is complete and verified. This step concludes the process for the configuration of the backplate.

During installation of the EV charger, if utilizing the EMS, the installer should install the corresponding EMS power monitoring cartridge first, prior to installing the EV charging system onto the mechanical mount at a parking spot. Once installed, the EMS will start scanning for Bluetooth signals and determining their received signal strength indicator (RSSI) and network latency.

During the commissioning process, the computation cartridge (i.e., a computational board 806 in a cartridge housing) from the modular charger unit can be plugged into a portable commissioning device/system that can power the cartridge over a 5V DC pin. This portable system will include a battery, the connection point, and/or a screen.

The installer can bring the powered computational cartridge from the modular charger unit close to the scanning EMS power monitoring cartridge, which can cause the EMS to recognize the computational cartridge to be commissioned. The EMS will connect to the powered computational cartridge via Bluetooth and transfer system information to the cartridge (including LoRa network configurations, mesh credentials, power draw maximums, etc.). The installer may confirm on a screen of the commissioning device/system that the information about the power limitations is accurate by checking the main breaker to which the EMS is connected to. This ensures that any changes made from the initial backplate installation are documented and accounted for. Once confirmed, the charger computation cartridge will save the information to an onboard non-volatile memory.

When the installer brings the computation cartridge back to the modular charger unit, the computation cartridge will transfer the stored information to a non-volatile memory of the interconnect board 804 to allow the computation cartridge to be replaced, if needed, without reprogramming.

According to some embodiments, once the above steps have been successfully completed and verified, the modular charger unit can be activated and may be used. In some implementations, to complete the commissioning process and bring the charger “online”, the installer may be required to provide the location of the modular charger unit (e.g., via a global positioning system (GPS) signal) and/or provide some additional information via his/her smart device.

### IV. Additional Considerations

The construction and arrangement of the elements of the apparatus as shown in the exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited.

Further, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes, and omissions may be made in the design, operating conditions, and arrangement of the exemplary embodiments without departing from the spirit of the present subject matter.

The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

It should be also understood that as used in the description herein the meaning of “a,” “an,” and “the” includes plural reference unless the context clearly dictates otherwise. Also, as used in the description herein, the meaning of “in” includes “in” and “on” unless the context clearly dictates otherwise.

Each numerical value presented herein is contemplated to represent a minimum value or a maximum value in a range for a corresponding parameter. Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention.

Although the concepts and principles of operation for the systems the Figures may have been described with a limited number of components for simplicity, these systems may include additional electrical and/or mechanical components necessary for their operation. Such components may include, but are not limited to, wire connectors, microprocessors, electronic controllers, transformers, power supplies, additional electrical control panels, etc. These additional components are within the spirit and the scope of this disclosure.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

What is claimed is:

1. A modular charger unit, comprising:
a housing comprising openings configured to receive respective cartridges;
an interconnect board within the housing comprising slots configured to receive one or more boards housed in cartridges, wherein the openings of the housing align with the slots on the interconnect board so that when a cartridge containing a board is inserted in an opening of the housing, the board in the cartridge is secured to a respective slot and is electrically connected to the interconnect board;
a computational board housed in a cartridge, the computational board being removably inserted to a first opening of the housing and to a first slot of the interconnect board;
a variable high voltage output (VHVO) board housed in a cartridge, the VHVO board being removably inserted to a second opening of the housing and to a second slot of the interconnect board;
a power board housed in a cartridge, the power board being removably inserted to a third opening of the housing and to a third slot of the interconnect board; and
an optional board housed in a cartridge, the optional board being removably inserted to a fourth opening of the housing and to a fourth slot of the interconnect board.

2. The modular charger unit of claim 1, wherein the computational board is operable to perform calculations within the modular charger unit and communicate with external devices or units.

3. The modular charger unit of claim 1, wherein the power board is operable to provide power monitoring, power controls, and direct current (DC) power supply to the modular charger unit.

4. The modular charger unit of claim 1, wherein the VHVO board is operable to receive data signals and power, and to provide an output to electrically connected charging devices.

5. The modular charger unit of claim 4, wherein the modular charger unit is an electric vehicle (EV) charger and the connected charging device is an EV.

6. The modular charger unit of claim 1, wherein the optional board adds functionality to the modular charger unit.

7. The modular charger unit of claim 1, wherein the optional board is a 120 Volt alternating current (AC) output adapter.

8. The modular charger unit of claim 1, wherein the computational board is operable to communicatively couple the modular charger unit to other modular charger units within a network node.

9. The modular charger unit of claim 1, wherein the modular charger unit is mechanically attached and electrically connected to a backplate of a pre-existing electrical system via the housing and one or more connectors.

10. An energy management system (EMS), comprising:
a communications cartridge operable to communicate with one or more high current applications (HCAs) that are electrically connected to the EMS; and
one or more power cartridges, wherein each power cartridge is electrically connected to a high current application (HCA) and electrically disposed between a master breaker and a subpanel of an apartment unit, and wherein each power cartridge is configured to monitor a power consumption of an electrical system of an apartment unit to which it is electrically connected.

11. The energy management system of claim 10, wherein the communications cartridge communicates with the one or more HCAs via a Long Range (LoRa) wireless communication network.

12. The energy management system of claim 10, wherein each of the one or more power cartridges is operable to shut off a power to a connected HCA when a monitored power from an apartment unit and/or the connected HCA exceeds an electrical limit.

13. The energy management system of claim 10, wherein each of the one or more power cartridges comprises an automatic transfer switch (ATS) operable to electrically isolate an apartment unit connected to the a power cartridge.

14. The energy management system of claim 13, wherein each of the one or more power cartridges is further configured, in a power outage situation, to electrically isolate an apartment unit via the ATS switch and allow an HCA to feed back power to the electrically isolated apartment unit.

15. The energy management system of claim 10, wherein the communications cartridge is operable to send a signal to connected HCAs about a maximum amount of electrical power drawn by the HCAs.

16. The energy management system of claim 10, wherein the EMS further comprises switch disconnects operable to directly connect a master breaker to a subpanel in an apartment when a power board is not installed for the apartment.

17. The energy management system of claim 10, wherein the one or more power cartridges are communicatively coupled to the HCAs via the communications cartridge.

18. An energy management system (EMS), comprising:
a communications backplate with a respective communication board operable to communicate with one or more high current applications (HCAs) that are electrically connected to the EMS; and
one or more power monitoring backplates with respective monitoring boards, wherein each power board is electrically connected to a high current application (HCA) and electrically disposed between a master breaker and a subpanel of an apartment unit, and wherein each monitoring board is configured to monitor a power consumption of an electrical system of an apartment unit to which it is electrically connected.

19. The energy management system of claim 18, wherein each power monitoring backplate is communicatively coupled with the communication board.

20. The energy management system of claim 18, wherein the communication board comprise a long range (LoRa) wireless communication network components that enable communications between the EMS and the one or more HCAs a wireless mesh network or a direct controller area network (CAN) wiring.
